(19) United States
(12) Patent Application Publication
(10) Pub. No.: US 2013/0021881 A1
(43) Pub. Date: Jan. 24, 2013

(54) PROTECTIVE GUARD FOR A WATCH

(71) Applicant: Michael H. Bertucci, Gurnee, IL (US)

(72) Inventor: Michael H. Bertucci, Gurnee, IL (US)

(21) Appl. No.: 13/551,782

(22) Filed: Jul. 18, 2012

Related U.S. Application Data
(60) Provisional application No. 61/509,307, filed on Jul. 19, 2011.

(51) Int. Cl. G04B 37/18

(52) U.S. Cl. 368/282; 368/286

(57) ABSTRACT

A protective guard for a watch is provided. The protective guard is formed of a high performance elastomer and is configured to be positioned over a watch in order to enhance impact, shock and abrasion resistance of the watch. The protective guard is secured in place on the watch by a friction fit with the watch and by a band extending through apertures at opposite ends of both the watch and the protective guard. The protective guard can be easily installed on the watch or removed from the watch as desired.

### CROSS-REFERENCE AND PRIORITY CLAIM

This application claims priority to U.S. Provisional Patent Application Ser. No. 61/509,307, filed Jul. 19, 2011, and entitled “PROTECTIVE GUARD FOR A WATCH”. U.S. Provisional Patent Application Ser. No. 61/509,307 is hereby incorporated by reference in its entirety.

### FIELD OF THE INVENTION

The invention relates to a protective guard for use with a watch.

### BACKGROUND OF THE INVENTION

Watches are primarily worn around the wrist of a user and because of this, watches are often subject to impact, shock and abrasion due to the various activities that a user will perform on a daily basis with his or her hands. Thus, it has been known in the art to provide for protective guards for watches in order to better protect the watches worn by users.

The protective guards that are known in the prior art, however, for example, U.S. Pat. Nos. 1,767,315, 2,582,473, 2,635,416, 2,692,070, 2,745,580, 3,584,455, 4,277,842, 4,509,644, 4,964,093, 6,199,730, 6,406,178 and 7,201,020, all have various drawbacks. For instance, some do not, in actuality, provide good impact, shock and/or abrasion resistance. Some are not formed of flexible materials which allow for the user to easily manipulate the protective guards as desired. Some are not UV, salt and/or chemical resistant. Some provide additional weight and bulk, such that the watches no longer provide an ergonomic design. Some are not easily installable on a watch or easily removable from a watch, especially where in some instances a user may desire to have the protective guard secured to the watch and in other instances the user may not desire to have the protective guard secured to the watch, or when it is desired to clean or repair the protective guard, the watch or the band. Some require tools in order to install or remove them from the watch.

In view of the foregoing, there is a need for a protective guard for a watch which provides all of these advantages.

### SUMMARY OF THE INVENTION

Briefly, the preferred embodiment of the invention provides for a protective guard for a watch. The protective guard is formed of a high performance elastomer and is configured to be positioned over a watch in order to enhance the impact, shock and abrasion resistance of the watch. The protective guard is secured in place on the watch by a friction fit with the watch and by a band extending through apertures at opposite ends of both the watch and the protective guard. The protective guard can be easily installed on the watch or removed from the watch as desired.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a preferred embodiment of the protective guard of the invention;

FIG. 2 is a front side view of the protective guard illustrated in FIG. 1;

FIG. 3 is a back side view of the protective guard illustrated in FIG. 1;

FIG. 4 is a top side view of the protective guard illustrated in FIG. 1;

FIG. 5 is a bottom side view of the protective guard illustrated in FIG. 1;

FIG. 6 is a left side view of the protective guard illustrated in FIG. 1;

FIG. 7 is a right side view of the protective guard illustrated in FIG. 1;

FIG. 8 is a top plan view of a watch casing upon which the protective guard is to be secured;

FIG. 9 is a cut perspective view of the protective guard illustrated in FIG. 1 being secured in working position to a watch and a band; and

FIG. 10 is a top perspective view of the protective guard illustrated in FIG. 1 where the protective guard is secured to the band, but moved out of position and securement with the watch.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

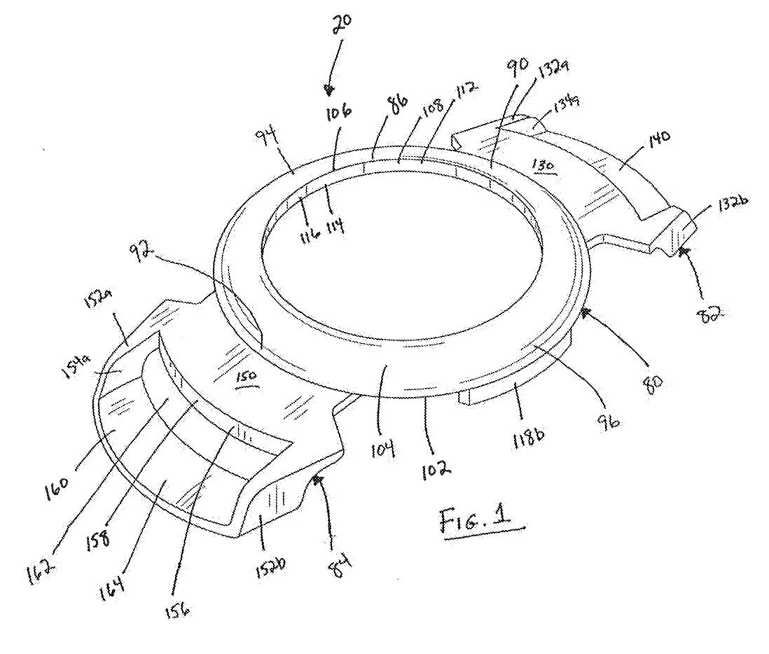

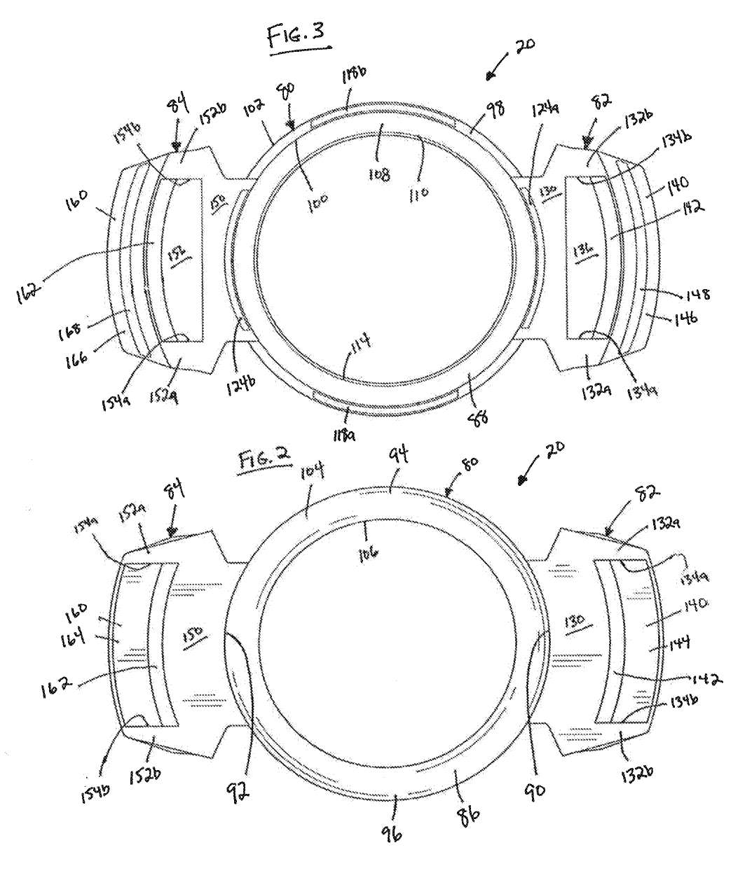

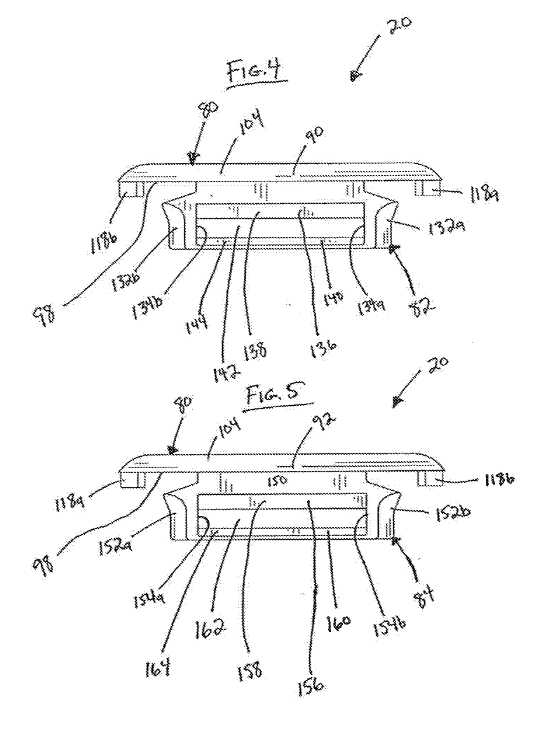

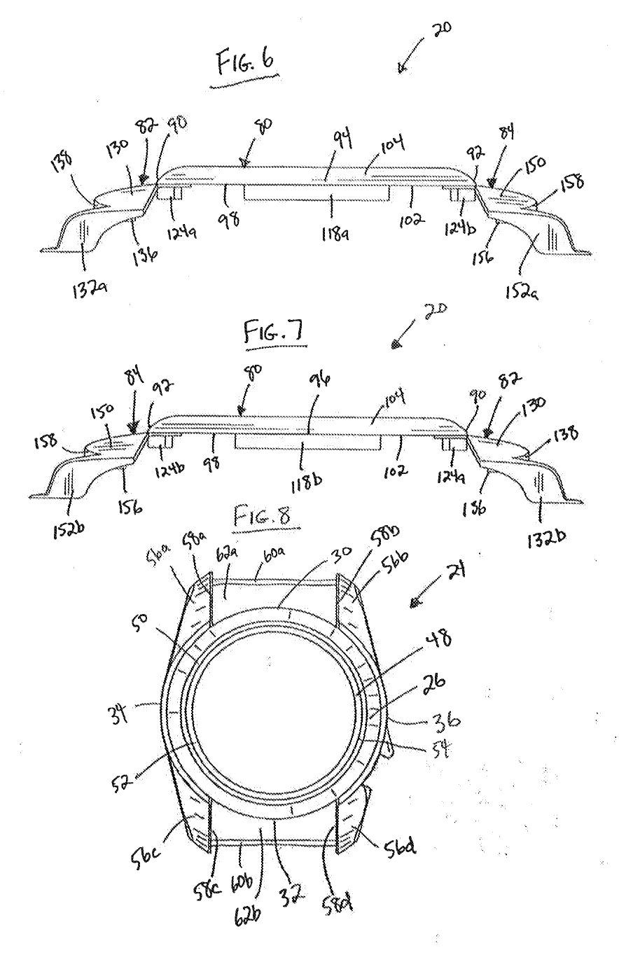

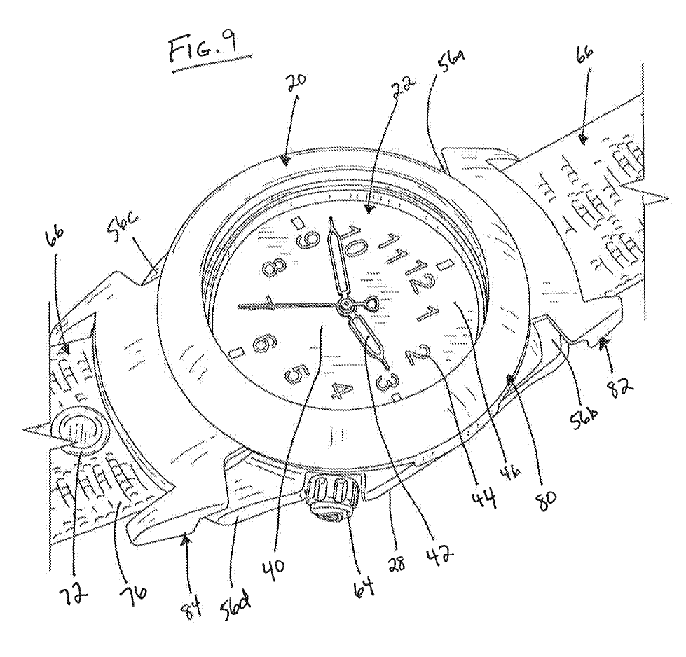

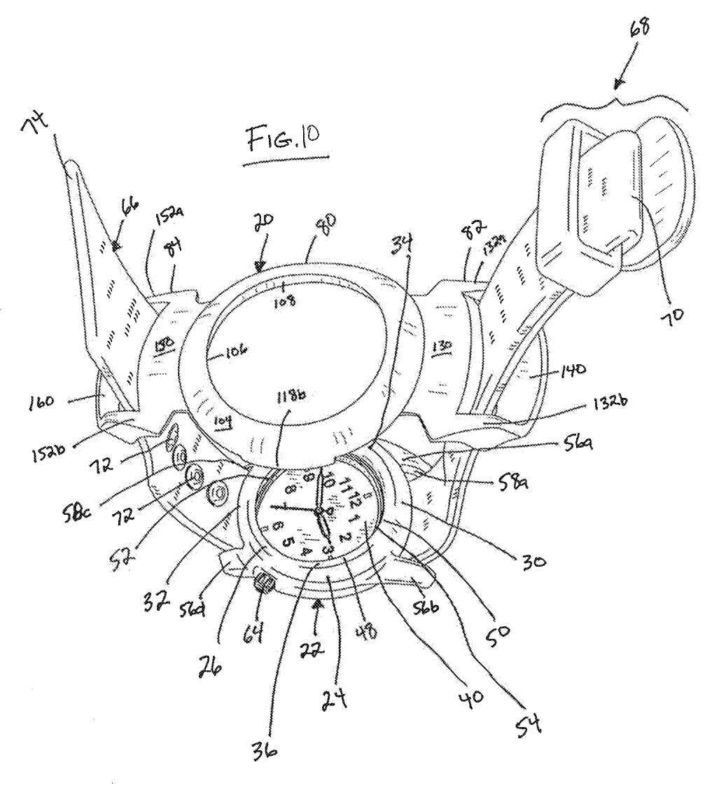

A protective guard 20 for a watch 22 is illustrated in FIGS. 1-7, 9 and 10. The protective guard 20 is preferably used in connection with a watch 22 of the general type illustrated in FIGS. 8-10, e.g., a field watch, but may also be used with other types of watches where applicable.

As best illustrated in FIGS. 8-10, the watch 22 includes a case 24 which houses various parts of the watch 22. The case 24 preferably has a front side 26 (which is visible to the user or wearer of the watch 22) and a back side 28 (which is not visible to the user or wearer of the watch 22, but rather is the side that typically lies against or adjacent to the skin of the wearer of the watch 22). When viewing the front side 26, the ease 24 also preferably has a top side 30, a bottom side 32, a left side 34 and a right side 36. A caseback (not shown) is provided on the back side 28 of the watch 22 and closes off the back side 28 of the case 24.

A face or dial 40 is provided on the front side 26 of the watch 22. The face 40 depicted is for an analog watch such that it includes the hands 42 and the numerals 44 used to tell time, however, it is to be understood that the watch 22 could alternatively have a digital face or a combination of analog and digital features. A crystal 46 covers the face 40. The crystal 46 can be formed of any appropriate material, including glass crystal, synthetic sapphire, plastic or sapphire crystal, but in every case the crystal 46 is preferably transparent such that a user or wearer of the watch 22 can see the face 40 of the watch 22.

The watch 22 also provides for a bezel 48 which surrounds the face 40. As shown in FIGS. 8-10, the bezel 48 is preferably integrally formed with the case 24. The bezel 48, however, may alternatively be non-integrally formed with the case 24, but connected to the case 24 or other appropriate part of the watch 22, in a manner that is well-known in the art. For instance, it is known for watches to have bezels that are movable or rotatable in order to allow for different timekeeping and/or mathematical functions. The bezel 48 preferably has first and second surfaces 50, 52 which are connected to one another at a bezel edge 54. The first surface 50 extends upwardly from the case 24 to the bezel edge 54, preferably in a curved manner as illustrated. The second surface 52 extends downwardly from the bezel edge 54 to the crystal 46, preferably in a straight, angled manner as illustrated.

The watch 22 also preferably includes four lugs 56a, 56b, 56c, 56d. Lug 56a extends outwardly from the case 24, generally proximate to or at the connection of the top side 30 and the left side 34. Lug 56b extends outwardly from the case 24, generally proximate to or at the connection of the top side 30 and the right side 36. Lugs 56a, 56b are generally spaced apart from one another and are generally parallel to one another. Lug 56c extends outwardly from the ease 24, generally proximate to or at the connection of the bottom side 32 and the left side 34. Lug 56d extends outwardly from the case 24, generally proximate to or at the connection of the bottom side 32 and the right side 36. Lugs 56c, 56d are generally spaced apart from one another and are generally parallel to one another. Inner surfaces 58a, 58c of lugs 56a, 56c are generally planar to one another and inner surfaces 58b, 58d of lugs 56b, 56c are generally planar to one another.

The watch 22 also further preferably includes a pair of bars 60a, 60b. Bar 60a preferably extends from the inner surface 58a of lug 56a to the inner surface 58b of lug 56b such that an aperture 62a is provided between the bar 60a, the inner surfaces 58a, 58b and the top side 30. Likewise, bar 60b preferably extends from the inner surface 58c of lug 56c to the inner surface 58d of lug 58d such that an aperture 62b is provided between the bar 60b, the inner surfaces 58c, 58d and the bottom side 32. Lugs 56a, 56b and bar 60a define a first lug assembly and lugs 56c, 56d and bar 60b define a second lug assembly. The bars 60a, 60b may be fixedly secured to the lugs 56a, 56b, 56c, 56d or may be removably secured to the lugs 56a, 56b, 56c, 56d, for instance in the ease where the bars 60a, 60b are spring bars, of the type known in the art.

The watch 22 further preferably provides for a crown or winding stem 64. The crown 64 is typically used to set the time and, if provided, the calendar, and, in the ease of mechanical watches, is used to wind the mainspring (not shown) which is housed within the case 24. The crown 64 preferably extends straight outwardly from the case 24 proximate to or at where the bottom side 32 of the ease 24 meets the right side 36 of the case 24.

A band 66 is operatively associated with the watch 22. In a preferred embodiment, the band 66 has a buckle and keeper assembly 68 provided at a first end 70 thereof and a plurality of eyelets 72 provided therethrough proximate to a second, opposite end 74 thereof. The buckle and keeper assembly 68 and the eyelets 72 work in combination to properly size and secure the watch 22 around the wrist of a user, as is well-known in the art. Other types of bands could also be provided for, as appropriate.

In the preferred embodiment, the second end 74 of the band 66 is inserted over the bar 60a, through the aperture 62a, under the back side 28 and the caseback, through the aperture 62b, and over the bar 60b until the back side 28 and the caseback preferably rest against a middle portion 76 of the band 66 provided between the buckle and keeper assembly 68 and the eyelets 72. The wearer of the watch 22 then secures the watch 22 around his/her wrist in a manner well-known in the art. Because the band 66 of the preferred embodiment is not physically connected to one or more of the lugs 56a, 56b, 56c, 56d, the bars 60a, 60d or the case 24 itself, the position of the band 66 relative to the case 24 can be adjusted in order to ensure the proper fit of the watch 22 around a user's wrist.

The watch 22 is usable as described above, however, the watch 22 may also be outfitted with the protective guard 20, as illustrated in FIGS. 1-10. The protective guard 20 is configured to provide extra protection to the watch 22 in various manners, for example, against impact, shock and abrasion. The protective guard 20 is preferably formed of a high performance elastomer, such that it is flexible, but such that it retains its original shape after being flexed. The protective guard 20 is also preferably formed of a material that is salt and chemical resistant. The protective guard 20 is also preferably formed of a material which is lightweight, such that when it is outfitted on the watch 22, the additional weight and bulk attributed to the protective guard 20 is generally negligible and not generally noticeable to the wearer of the watch 22.

The protective guard 20 has a central, watch protection portion 80 and first and second band connecting portions 82, 84 which extend from opposite ends of the watch protection portion 80.

The watch protection portion 80 of the protective guard 20 is configured to engage and protect a watch. In the preferred embodiment, the watch protection portion 80 of the protective guard 20 is configured to engage the case 24 and bezel 48 of the watch 22 in order to protect the case 24, the bezel 48 and the crystal 46 of the watch 22. It is to be understood that the configuration of the watch protection portion 80 could be modified as desired or necessary in order to engage different configured cases and bezels of differently configured watches.

In the preferred embodiment, the watch protection portion 80 preferably has a front side 86 (which is visible to the user or wearer of the watch 22) and a back side 88 (which is not visible to the user or wearer of the watch 22, but rather is the side that typically lies against or adjacent to the watch 22). When viewing the front side 86, the watch protection portion 80 also preferably has a top side 90, a bottom side 92, a left side 94 and a right side 96.

In the preferred embodiment, the watch protection portion 80 is generally formed in the shape of a circular ring. The watch protection portion 80 has a circular, horizontal base surface 98 which is visible from the back side 88. The horizontal base surface 98 has an inner edge 100 and an outer edge 102. The watch protection portion 80 further includes an outer surface 104 which extends upwardly and inwardly from the outer edge 102 to a top edge 106 of the watch protection portion 80. In a preferred embodiment, the outer surface 104 is at least partially curved as best illustrated in FIGS. 1 and 4-7. The watch protection portion 80 further includes an inner surface 108 which extends upwardly and inwardly from the inner edge 100 to a bottom edge 110 of the watch protection portion 80. In a preferred embodiment, the inner surface 108 is at least partially curved as best illustrated in FIG. 3. In a preferred embodiment, the inner surface 108 and the outer surface 104 are generally planar/concentric with one another, depending on their configurations. The watch protection portion 80 further includes an inner wall 112 which extends between the bottom edge 110 and the top edge 106. The inner wall 112 may extend vertically or at an angle between the top and bottom edges 106, 110, depending on the configuration of the bezel 48.

The watch protection portion 80 further preferably includes an inner flange 114 which extends downwardly from the inner surface 108 proximate to the bottom edge 110 such that an inner surface 116 of the inner flange 114 is preferably flush with the inner wall 112. The inner flange 114 preferably does not extend as far downward to the base surface 98. In the preferred embodiment, the inner flange 114 is also preferably circular/cylindrical in configuration and extends continuously, however, it is to be understood that the inner flange 114 could be formed in a different configuration or could be separated into a plurality of separated inner flanges, if desired. It is also to be understood that, if desired, the inner flange 114 could be removed from the watch protection portion 80, for instance, in the case where the second surface 52 of the bezel 48 is not provided such that the crystal 46 of the watch 22 is flush with the bezel edge 54.

The watch protection portion 80 further preferably includes two outer flanges, namely a left side flange 118a and a right side flange 118b. The left side flange 118a preferably extends downwardly from a left side 120 of the base surface 98 of the watch protection portion 80. The right side flange 118b preferably extends downwardly from a right side 122 of the base surface 98 of the watch protection portion 80. The left and right side flanges 118a, 118b are preferably positioned directly opposite one another. The left and right side flanges 118a, 118b are preferably arcuate in configuration so that they match the curvature of the base surface 98.

The watch protection portion 80 further preferably includes two further outer flanges, namely a top side flange 124a and a bottom side flange 124b. The top side flange 124a preferably extends downwardly from a top side 126 of the base surface 98 of the watch protection portion 80. The bottom side flange 124b preferably extends downwardly from a bottom side 128 of the base surface 98 of the watch protection portion 80. The top and bottom side flanges 124a, 124b are preferably positioned directly opposite one another. The top and bottom side flanges 124a, 124b are preferably arcuate in configuration so that they match the curvature of the base surface 98. The top and bottom side flanges 124a, 124b preferably extend further downwardly from the base surface 98 of the watch protection portion 80 than do the left and right side flanges 118a, 118b. The top and bottom side flanges 124a, 124b also preferably extend longer in arcuate length along the base surface 98 than do the left and right side flanges 118a, 118b.

The first band connecting portion 82 of the protective guard 20 extends outwardly from the top side 90 of the watch protection portion 80 of the protective guard 20. The first band connecting portion 82 is preferably connected, preferably in an integrally formed manner, to at least one of and preferably to both the outer surface 104 and the circular, horizontal base surface 98 of the watch protection portion 80 of the protective guard 20.

The first band connecting portion 82 has an extension portion 130 which is connected to the watch protection portion 80 at a first end thereof and which extends to a second end which is distanced from the watch protection portion 80.

The first band connecting portion 82 includes first and second lugs 132a, 132b. Lug 132a extends outwardly from the second end of the extension portion 130 at a first side thereof and lug 132b extends outwardly from the second end of the extension portion 130 at a second, opposite side thereof. Lugs 132a, 132b are generally spaced apart from one another and are generally parallel to one another. Lugs 132a, 132b define inner surfaces 134a, 134b, respectively.

The first band connecting portion 82 farther preferably includes a reinforcement portion 136 which is secured to an underside of the extension portion 130 and provided between the first and second lugs 132a, 132b. The reinforcement portion 136 provides a downwardly and outwardly extending wall 138 between the lugs 132a, 132b which is concentric with the arcuate configuration of the outer surface 104 of the watch protection portion 80.

The first hand connecting portion 82 further includes a bar 140. Bar 140 preferably extends from the inner surface 134a of lug 132a to the inner surface 134b of lug 132b such that an aperture 142 is provided between the bar 140, the inner surfaces 134a, 134b of lugs 132a, 132b and the reinforcement portion 136. Bar 140 is positioned outward of, and below, the extension portion 130.

A top surface 144 of the bar 140 may be provided with indicia, if desired. A bottom surface 146 of the bar 140 may be provided with a groove 148 which extends along a length thereof.

The second band connecting portion 84 of the protective guard 20 is preferably identical to the first band connecting portion 82 of the protective guard 20, except that it is provided on an opposite side of the protective guard 20, thereby essentially making the second band connecting portion 84 the mirror image of the first band connecting portion 82. More specifically, the second band connecting portion 84 of the protective guard 20 extends outwardly from the bottom side 92 of the watch protection portion 80 of the protective guard 20. The second band connecting portion 84 is preferably connected, preferably in an integrally formed manner, to at least one of and preferably to both the outer surface 104 and the circular, horizontal base surface 98 of the watch protection portion 80 of the protective guard 20.

The second band connecting portion 84 has an extension portion 150 which is connected to the watch protection portion 80 at a first end thereof and which extends to a second end which is distanced from the watch protection portion 80.

The second band connecting portion 84 includes first and second lugs 152a, 152b. Lug 152a extends outwardly from the second end of the extension portion 150 at a first side thereof and lug 152b extends outwardly from the second end of the extension portion 150 at a second, opposite side thereof. Lugs 152a, 152b are generally spaced apart from one another and are generally parallel to one another. Lugs 152a, 152b define inner surfaces 154a, 154b, respectively.

The second band connecting portion 84 further preferably includes a reinforcement portion 156 which is secured to an underside of the extension portion 150 and provided between the first and second lugs 152a, 152b. The reinforcement portion 156 provides a downwardly and outwardly extending wall 158 between the lugs 152a, 152b which is concentric with the arcuate configuration of the outer surface 104 of the watch protection portion 80.

The second band connecting portion 84 further includes a bar 160. Bar 160 preferably extends from the inner surface 154a of lug 152a to the inner surface 154b of lug 152b such that an aperture 162 is provided between the bar 160, the inner surfaces 154a, 154b of lugs 152a, 152b and the reinforcement portion 156. Bar 160 is positioned outward of, and below, the extension portion 150.

A top surface 164 of the bar 160 may be provided with indicia, if desired, although it preferably is not for reasons which will be discussed hereinbelow. A bottom surface 166 of the bar 160 is preferably provided with a groove 168 which extends along a length thereof.

In order to utilize the preferred embodiment of the protective guard 20 of the invention with the watch 22 and band 66 described and illustrated, the protective guard 20 is preferably first placed in position on the watch 22. The top side 80 of the watch protection portion 80 is positioned near the 12:00 position on the watch 22 (which can be determined by the numerals 44 on the face 40 of the watch 22). If desired, the bar 140 of the protective guard 20 could be provided with identifying indicia on the top surface 144 thereof in order to assist the user in determining where the top side 80 of the watch protection portion 80 is located.

With the watch protection portion 80 in position on the watch 22, the inner surface 108 of the watch protection portion 80 preferably lays against the first surface 50 of the bezel 48 of the watch 22 and the inner flange 114 of the watch protection portion 80 preferably lays against the second surface 50 of the bezel 48 of the watch 22. The left side flange 118a preferably lays against the left side 34 of the case 24, the right side flange 118b preferably lays against the right side 36 of the case 24, the top side flange 124a preferably lays against the top side 30 of the case 24, and the bottom side flange 124b preferably lays against the bottom side 32 of the case 24. The left side flange 118a may also come into contact with portions of the lugs 56a, 56c and the right side flange 118b may also come into contact with portions of the lugs 56b, 56d. The first and second band connecting portions 82, 84 only preferably come into contact with the watch 22 when at rest by inner edges of the extension portions 130, 150, respectively, contacting the top and bottom sides 30, 32 of the case 24, respectively. Thus, at rest, the first and second band connecting portions 82, 84 essentially are preferably suspended above and extend beyond the lugs 56 and the bars 60 of the watch 22. The positioning of the watch protection portion 80 in this manner provides a friction fit with the watch 22 thereby providing some stability to the positioning of the watch protection portion 80 to the watch 22.

In order to further ensure the positioning and stability of the watch protection portion 80 on the watch 22, the second end or tip 74 of the band 66 is brought over the bar 140 of the first band connecting portion 82, into and through the aperture 142 defined by the first hand connecting portion 82, over the bar 60a of the watch 22, and into and through the aperture 62a defined by the watch 22. The second end or tip 74 of the band 66 is then further moved under the back side 28 of the case 24 and the caseback of the watch 22. The second end or tip 74 of the band 66 is then further moved through the aperture 62b defined by the watch 22, over the bar 60b of the watch 22, into and through the aperture 162 defined by the second band connecting portion 84, and over the bar 160 of the second band connecting portion 84.

The band 66 is then further moved until, preferably, the eyelets 72 have been moved through the aperture 162 of the second hand connecting portion 84. The band 66 is prevented from moving all the way through the watch 22 and the protective guard 20 by the provision of the buckle and keeper assembly 68 provided at or proximate to the first end 70 of the band 66. The band 66 is then secured around a user's wrist in the normal and well-known fashion (e.g., by using the eyelets 72 and the buckle and keeper assembly 68), and the position of the watch 22 and the protective guard 20 can then be further adjusted by sliding the watch 22 and protective guard 20 along the band 66. The grooves 148, 168 on the bottom surfaces 146, 166 of the bars 140, 160 of the first and second band connecting portions 82, 84 assist in providing an air or perspiration vent as well as traction on skin.

in order to prevent the first and second band connecting portions 82, 84 from being moved too much during the insertion and removal of the band 66 through the apertures 142, 162, the reinforcement portions 136, 156 may come into contact with the lugs 56 of the watch 22, thereby preventing further downward movement of the first and second band connecting portions 82, 84 relative to the watch 22.

Thus, the protective guard 20 of the preferred embodiment of the invention provides a number of useful and novel advantages. The protective guard 20 improves impact and shock resistance of the watch 22. The protective guard 20 provides protection for the watch 22 from abrasion. The protective guard 20 is UV, salt and chemical resistant. The protective guard 20 also provides an ergonomic design that does not add bulk or weight to the assembly of the watch 22 and band 66. The protective guard 20 is also easily removable from the watch 22 and the band 66 so that the protective guard 20, the watch 22 and/or the band 66 can be easily cleaned, if necessary. Furthermore, no special tools are required to install or remove the protective guard 20 from the watch 22 or the band 66. The protective guard 20 also does not interfere with operation of the crown 64.

It is to be understood that the exact configuration of the protective guard 20 that is described and illustrated is for a preferred embodiment of the protective guard 20 and is not intended to be limiting in nature in any way. It is also to be understood that the method of attaching the protective guard 20 to the watch 22 and the band 66 as described and illustrated is also a preferred embodiment, but that the attachment of the protective guard 20 to the watch 22 and the band 66 could be performed by other methods, such as by first partially securing the protective guard 20 to the band 66, then by securing the band 66 and the protective guard 20 to the watch 22, and then by finally securing the protective guard 20 to the band 66.

In the alternative, the configuration of the watch 22 could be changed if the protective guard 20 is utilized. More specifically, the watch 22 need not necessarily he configured to have the first and second lug assemblies as the band 66 being inserted through the apertures 142, 162 of the protective guard 20 and being positioned against the back side 28 of the case 24 and the caseback of the watch 22 will effectively hold the assembly of the watch 22, band 66 and protective guard 20 together.

In another alternative, the band 66 need not necessarily be of the type described and illustrated herein. Alternatively, the band 66 could have opposite ends, with one end being secured to the first lug assembly of the watch 22 and the opposite end being secured to the second lug assembly of the watch 22. In such an instance, the band 66 would still extend through the apertures 142, 162 of the protective guard 20, such that the assembly of the watch 22, band 66 and protective guard 20 will be effectively held together. Such an assembly, however, is to be utilized in situations where it is not necessarily ideal to be able to remove and install the protective guard 20 from the watch 22 and band 66 as desired (as is discussed above with the preferred embodiment), but rather is meant to be more of a permanent configuration.

While a preferred embodiment of the present invention is shown and described, it is envisioned that those skilled in the art may devise various modifications of the present invention without departing from the spirit and scope of the invention.

What is claimed:

1. A protective guard for a watch, said protective guard comprising:
a central portion having top and bottom sides, a base surface, an inner wall, an outer surface which extends from an outer edge of said base surface to a top edge of said inner wall, and an inner surface which extends from an inner edge of said base surface to a bottom edge of said inner wall, said central portion further having at least one outer flange which extends downwardly from said base surface;
a first portion having an extension portion, first and second lugs, and a bar, said extension portion of said first portion extending from said top side of said central portion and being connected to at least one of said outer surface and said base surface of said central portion, said first and second lugs extending outwardly from said extension portion and being spaced apart from one another, said bar extending between said first and second lugs to define a first aperture between said bar, said first and second lugs, and said extension portion; and
a second portion having an extension portion, first and second lugs, and a bar, said extension portion of said second portion extending from said bottom side of said central portion and being connected to at least one of said outer surface and said base surface of said central portion, said first and second lugs extending outwardly from said extension portion and being spaced apart from one another, said bar extending between said first and second lugs to define a second aperture between said bar, said first and second lugs, and said extension portion.

2. The protective guard as defined in claim 1, wherein said central portion further has at least one inner flange which extends downwardly from said inner surface and is substantially flush with said inner wall.

3. The protective guard as defined in claim 1, wherein said central portion has four outer flanges which extend downwardly from said base surface.

4. The protective guard as defined in claim 3, wherein a first outer flange extends downwardly from said base surface at said top side of said central portion, wherein a second outer flange extends downwardly from said base surface at said bottom side of said central portion, wherein a third outer flange extends downwardly from said base surface between said top and bottom sides of said central portion, and wherein a fourth outer flange extends downwardly from said base surface between said top and bottom sides of said central portion and generally opposite said third outer flange.

5. The protective guard as defined in claim 4, wherein said first and second outer flanges extend further downwardly from said base surface of said central portion than said third and fourth outer flanges.

6. The protective guard as defined in claim 1, wherein said extension portions of said first and second portions are positioned proximal to said central portion, and wherein said bars of said first and second portions are positioned distal to said central portion.

7. The protective guard as defined in claim 1, wherein said extension portions of said first and second portions are positioned above said bars of said first and second portions.

8. The protective guard as defined in claim 1, wherein said first portion further defines a reinforcement portion which extends downwardly from an underside of said extension portion between said first and second lugs, said first aperture of said protective guard being defined by said reinforcement portion, said first and second lugs and said bar, and wherein said second portion further defines a reinforcement portion which extends downwardly from an underside of said extension portion between said first and second lugs, said second aperture of said protective guard being defined by said reinforcement portion, said first and second lugs and said bar.

9. An assembly comprising:
a watch having front and back sides;
a protective guard having a central portion and first and second portions extending from opposite sides of said central portion, said central portion being positioned to rest against at least a portion of said front side of said watch, each of said first and second portions having an aperture which extends therethrough; and
a band having first and second end portions and a middle portion provided therebetween, said band extending through said apertures of said first and second portions of said protective guard, whereby said middle portion of said band is positioned to face said back side of said watch, said first portion of said protective guard is positioned between said watch and said first end portion of said band, and said second portion of said protective guard is positioned between said watch and second end portion of said band.

10. The assembly as defined in claim 9, wherein said first end portion of said band is provided with a buckle and keeper assembly, and wherein said second end portion of said band has a plurality of eyelets provided therethrough.

11. The assembly as defined in claim 9, wherein said watch further comprises a case, a face provided on said front side of said watch, and a bezel provided on said front side of said watch which surrounds said face.

12. The assembly as defined in claim 11, wherein said bezel is integrally formed with said case.

13. The assembly as defined in claim 11, wherein said bezel has a first surface which extends from said case to an edge of said bezel, said central portion of said protective guard having an inner surface which is positioned to lay against at least a portion of said first surface of said bezel.

14. The assembly as defined in claim 13, wherein said bezel has a second surface which extends from said edge of said bezel toward said face, said central portion of said protective guard having at least one inner flange which is positioned to lay against at least a portion or said second surface of said bezel.

15. The assembly as defined in claim 14, wherein said watch further comprises a crystal which covers said face, said second surface of said bezel extends from said bezel edge to said crystal.

16. The assembly as defined in claim 11, wherein said central portion of said protective guard has at least one outer flange which is positioned to lay against at least a portion of said case.

17. The assembly as defined in claim 16, wherein said central portion of said protective guard has four outer flanges.

18. The assembly as defined in claim 9, wherein each of said first and second portions of said protective guard comprises an extension portion, first and second lugs, and a bar, said extension portion being connected to said central portion of said protective guard, said first and second lugs extending outwardly and from opposite sides of said extension portion, said bar extending between said first and second lugs, said aperture of each of said first and second portions of said protective guard being formed between said extension portion, said bar and said first and second lugs.

19. The assembly as defined in claim 18, wherein said extension portions of said protective guard are positioned proximal to said watch and said bars of said protective guard are positioned distal to said watch.

20. The assembly as defined in claim 18, wherein said extension portions of said protective guard are positioned above said bars of said protective guard.

21. The assembly as defined in claim 18, wherein said watch has first and second pairs of lugs extending outwardly from opposite ends thereof, respectively, and wherein said watch has a bar extending between each of said first and second pairs of lugs such that apertures are defined between said watch, said first and second pairs of lugs, and each bar, wherein said band extends through each aperture defined between said watch, said first and second pairs of lugs and each bar.

22. The assembly as defined in claim 21, wherein said first portion of said protective guard extends over and beyond said first pair of lugs and the associated bar of said watch, said first portion of said protective guard being configured to abut against said first pair of lugs when said band is secured around a wrist of a user, and wherein said second portion of said protective guard extends over and beyond said second pair of lugs and the associated bar of said watch, said second portion of said protective guard being configured to abut against said second pair of lugs when said band is secured around a wrist of a user.

23. An assembly comprising:
a watch having front and back sides, top and bottom sides, and first and second lug assemblies, said first lug assembly extending outwardly from said top side, said second lug assembly extending outwardly from said bottom side;
a protective guard having a central portion and first and second portions extending from opposite sides of said central portion, said central portion being positioned to rest against at least a portion of said front side of said watch, each of said first and second portions of said protective guard having an aperture defined therethrough, said first portion being suspended above and extending beyond said first lug assembly, said second portion of said protective guard being suspended above and extending beyond said second lug assembly; and
a band which is operatively secured to said watch and which extends through said apertures of said first and second portions of said protective guard in order to operatively secure said band, said protective guard and said watch to one another.

24. The assembly as defined in claim 23, wherein said first lug assembly defines first and second lugs and a bar, said first and second lugs of said first lug assembly extending outwardly from said top side and being spaced apart from one another, said bar of said first lug assembly extending between said first and second lugs of said first lug assembly to define an aperture of said first lug assembly, said second lug assembly defining first and second lugs and a bar, said first and second lugs of said second lug assembly extending outwardly from said bottom side and being spaced apart from one another, said bar of said second lug assembly extending between said first and second lugs of said second lug assembly to define an aperture of said second lug assembly.

25. The assembly as defined in claim 24, wherein said band has first and second end portions and a middle portion defined therebetween, said band being operatively secured to said watch by having said band extend through said apertures of said first and second lug assemblies of said watch, whereby said middle portion of said band is positioned to face said back side of said watch, said watch being positioned between said first and second end portions of said band.

26. The assembly as defined in claim 25, wherein said band, said protective guard and said watch are operatively associated to one another by having said band extend through said aperture of said first portion of said protective guard, through said aperture of said first lug assembly, through said aperture of said second lug assembly, and through said aperture of said second portion of said protective guard, whereby said middle portion of said band is positioned to face said back side of said watch, said first portion of said protective guard is positioned between said watch and said first end portion of said band, and said second portion of said protective guard is positioned between said watch and second end portion of said band.

27. An assembly comprising:
a watch having front and back sides, a case, a face, a bezel, first and second pairs of lugs, and first and second bars, said face being provided on said front side of said watch, said bezel being provided on said front side of said watch and surrounding said face, said bezel having a first surface which extends from said case to an edge of said bezel, said first and second pairs of lugs extending outwardly from opposite sides of said case, said first bar extending between said first pair of lugs, said case, said first pair of lugs and said first bar defining a first aperture of said watch, said second bar extending between said second pair of lugs, said case, said second pair of lugs and said second bar defining a second aperture of said watch;
a protective guard having a central portion and first and second portions extending from opposite sides of said central portion, said central portion having an inner surface which is positioned to lay against at least a portion of said first surface of said bezel, said central portion of said protective guard having at least one first outer flange which is positioned to lay against at least a portion of said case between one of said first and second pairs of lugs of said watch, said central portion of said protective guard having at least one second outer flange which is positioned to lay against at least a portion of said case between said first and second pairs of lugs of said watch, each of said first and second portions of said protective guard comprises an extension portion, first and second lugs, and a bar, said extension portion being connected to said central portion of said protective guard, said first and second lugs extending outwardly and from opposite ends of said extension portion, said bar extending between said first and second lugs, said extension portion, said bar and said first and second lugs of said first portion of said protective guard defining a first aperture of said protective guard, said extension portion, said bar and said first and second lugs of said second portion of said protective guard defining a second aperture of said protective guard, said extension portions of said protective guard being positioned proximal to said watch and said bars of said protective guard being positioned distal to said watch, said extension portions of said protective guard being positioned above said bars of said protective guard; and
a band having first and second end portions and a middle portion provided therebetween, said band extending through said first aperture of said first portion of said protective guard, through said first aperture of said watch, through said second aperture of said watch, and through said second aperture of said protective guard, whereby said middle portion of said band is positioned to face said back side of said watch, said first portion of said protective guard is positioned between said watch and said first end portion of said band, and said second portion of said protective guard is positioned between said watch and second end portion of said band.
